(19) United States
(12) Patent Application Publication
(10) Pub. No.: US 2005/0021350 A1
(43) Pub. Date: Jan. 27, 2005

(54) System and method for managing contract labor data elements

(76) Inventors: Bryan Scott, Plano, TX (US); Warren Tennant, Houston, TX (US); Ramon Perales, Plano, TX (US)

Correspondence Address: Steven Thrasher, 391 Sandhill Dr., Richardson, TX, 75080, US

(21) Appl. No.: 10/626,945

(22) Filed: Jul. 25, 2003

(51) Int. Cl. G06F 17/60

(52) U.S. Cl. 705/1

(57) ABSTRACT

This invention is a system and method for managing contract labor data elements. Preferably, the contract labor data management method is embodied as a system that maintains safety, qualification, background, and insurance data elements for contract labor employees. The system comprises a data aggregation service provider having a data collection system, a data management system, a data storage system, and data retrieval system and comprises at least one subscriber, contract labor provider, data collection service provider, and job site. The contract labor data management system provides an method for collecting and providing real time access of contract labor employee data elements to the subscriber, job site, or contract labor provider. A subscriber is an individual or company that audits a contract labor employee at a job site. A data collection service provider is any individual or company that collects and/or provides data about a contract labor employee to the data aggregation service provider. A job site is any location where a contract labor employee provides, has provided, or will provide a service.

### TECHNICAL FIELD

The present invention generally relates to data management systems, and more specifically to contract labor data management systems.

### STATEMENT OF A PROBLEM ADDRESSED BY THIS INVENTION

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art

Discussion

Companies are confronted with the management of contract labor security, safety, qualification, background, and insurance data elements at job sites such as oil refineries, manufacturing facilities, and long-haul trucking agencies, for example. These companies mandate that contract labor providers comply with rules and regulations that keep security, safety, qualification, background, and insurance data elements current for all of their employees. Companies have mandated rules and regulations to decrease job site incidents, prevent costly job site accidents, and prevent terrorist attacks.

Companies that manage job sites may randomly audit contract labor employee data elements. Audits are preformed to verify contract labor provider compliance with mandated company rules and regulations. At times, audits yield that an unqualified contract labor employee is working or has been working on a job site. In addition, audits yield that an unqualified contract labor employee may have a drug and alcohol history providing a risk to the job site and other job site personnel increasing liability and decreasing compliance with regulations. Contract labor providers are penalized for these violations and both contract labor providers and companies incur down time while facilitating the replacement process.

Unfortunately, efficiently managing employee security, safety, qualifications, background, and insurance data elements is difficult and time consuming. Inefficient management of contract labor employees leads to more unqualified contract labor employees working on job sites. In more severe instances, unnoticed unqualified contract labor employees may lead to increased incidents, costly job site accidents, or terrorist acts that may irreversibly harm the environment or claim human life.

### SELECTED OVER VIEW OF SELECTED EMBODIMENTS

This invention provides technical advantages as a system and method for contract labor data management, thereby reducing the number of unqualified contract labor employees working on a job site. In addition, by reducing the number of unqualified contract labor employees working on a job site the number of incidents, job site accidents, and terrorist attacks may be minimized. Preferably, the contract labor data management method is embodied as a system that maintains safety, qualification, background, and insurance data elements for contract labor employees, complying with company rules and regulations.

The contract labor data management method, embodied as a system, comprises a data aggregation service provider having a data collection system, a data management system, a data storage system, and data retrieval system and a subscriber, a contract labor provider, a data collection service provider, and a job site. The contract labor data management system provides a method for collecting and providing real time access of contract labor employee data elements to the subscriber, job site, and contract labor provider. A subscriber is an individual or company that audits a contract labor employee at a job site. A data collection service provider is any individual or company that collects and/or provides data about a contract labor employee to the data aggregation service provider. A job site is any location where a contract labor employee has worked, is working, or will work. A contract labor data element is any information that is specific to a contract labor employee.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 illustrates a contract labor data management system.

FIG. 2 illustrates a method for automating data collection from a data collection service provider.

FIG. 3 illustrates a preferred method for automating notification of contract labor data element status.

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for-functioning-” or “step for-functioning-” in the Claims section.

Discussion of the Figures

The invention can be characterized as a method and system for a data aggregation service provider to collect contract labor employee data elements from different source types, verify the data elements meet criteria, store the data elements in an electronic repository, provide reporting, and provide real-time access to the stored data elements. In a preferred embodiment, the method may be implemented as a system that collects, verifies, stores, reports, and provides real-time access to data elements, such as a software program, for example. In an alternative embodiment, the method may be embodied as multiple software systems that work together to collect, verify, store, report, and provides real-time access to data elements.

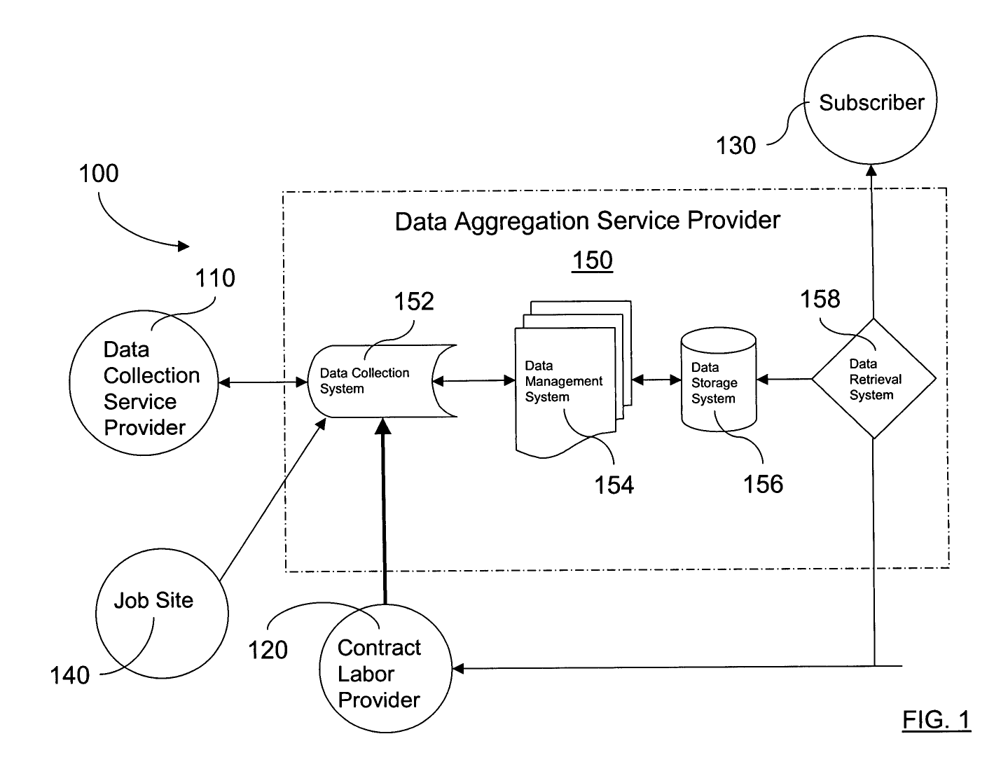

Features and advantages of the invention can be better understood by reviewing FIG. 1, which illustrates a contract labor data management system 100 for collecting contract labor data elements from different source types, processing the data elements, providing reporting, and making the data elements available for real-time review to at least one subscriber. The data aggregation model 100 comprises a data collection service provider 110, a contract labor provider 120, a subscriber 130, a job site 140, and a data aggregation service provider 150.

The data collection service provider 110 is any service provider that may be utilized to collect data elements required by the data aggregate service provider 150 such as security, safety, certification, and insurance data elements, for example. A single piece of data is a data element. A collection of data elements are a record. A data element that has been adapted, modified, processed, or queried is a data element result. Furthermore, security data may include biometrics, tenure, and background checks. Background checks have become mandatory at a majority of job sites in order to reduce the likelihood of a terrorist attack. Safety data elements may include drug and alcohol testing, prior safety records, and time since last incident. Certification data elements may include trade certifications, years of experience, and academic degrees. In a preferred embodiment, at least one data collection service provider 110 may be incorporated within the data aggregation service provider 150. In an alternative embodiment, a data collection service provider 110 may be any outside entity that the data aggregation service provider 150 enters into a partnership. An entity is any organization that is independent, separate, or has a self-contained existence from the data collection service provider 150.

A contract labor provider 120 is any entity that provides contract labor to a job site 140. A person that works on behalf of a contract labor provider 120 is an employee. A job site 140 is any location where at least one employee is required to complete at least one task. A job site may include an oil installation, chemical installation, or gas installation, for example. In addition, it is apparent to those skilled in the art that a job site may also include any roadway, construction site, shipyard, or manufacturing facility wherein contract labor is utilized.

A subscriber 130 is any person or company that reviews the security, safety, and qualification data of an employee that has worked, is working, or will work on a job site 140. A subscriber 130 may work for an oil, trucking, manufacturing, construction, or regulatory agency. In a preferred embodiment, a subscriber 130 is a person that audits contract labor employee data elements on at least one job site 140. In an alternative embodiment, a subscriber 130 is a department at an oil company that reviews the safety and/or qualification data elements of contract labor employees on at least one company job site. In yet another alternative embodiment, a subscriber 130 may be a single individual such as an independent contractor that works for an automobile labor union who validates union workers safety data elements prior to offering a new or renewing a union worker membership, for example.

A data aggregation service provider 150 is any person or company that collects data elements from different source types, verifies the data elements meet criteria, stores the data elements in an electronic repository, provides reporting, and provides real-time access to the stored data elements. A data aggregation service provider 150 comprises a data collection system 152, a data management system 154, a data storage system 156, and a data retrieval system 158.

The data collection system 152 is any system that collects a data element request from a contract labor provider 120, accepts time entry from an employee at a job site 140, or provides a method for receiving data elements from a data collection service provider 110 such as a drug and alcohol testing lab, for example. The data management system 154 is any system that is enabled to manage the data elements received from the data collection system 152 and manage the data elements stored in the data storage system 156. In a preferred embodiment, the data management system 154 may formulate intelligent requests to a data collection service provider 110 based on criteria stored in the data stored system 156. In addition, the data management system 154 may generate preformatted automated reports to a service provider, job site, or subscriber. The data storage system 156 may be any system that stores electronic data, such as a database or file server, for example. Databases may include Oracle, SQL Server, Informix, or DB2 databases, for example. File servers may include image servers and document servers, for example.

The data retrieval system 158 may be any system that provides real-time access to data elements stored in the data storage system 156. The data retrieval system 158 will be accessible to a subscriber 130 and/or contract labor provider 120. In addition, the data retrieval system 158 will provide remote data element access, such as, imaged drug and alcohol tests and background check reports, for example.

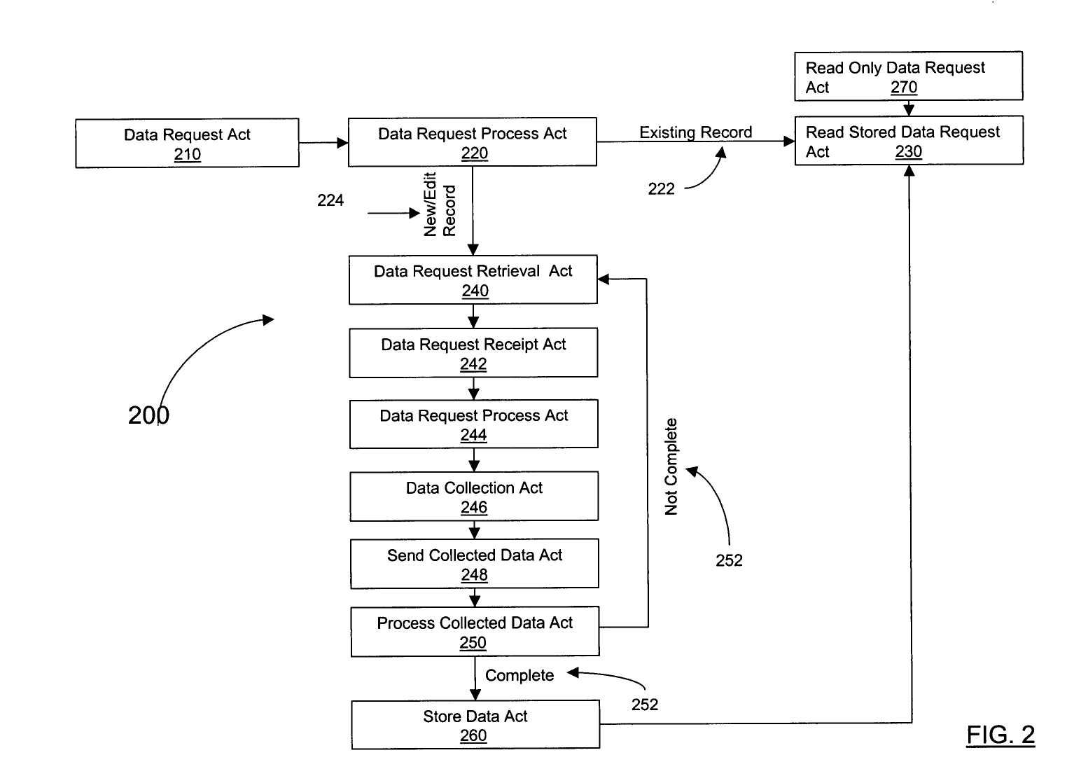

FIG. 2 illustrates a method for automating data element collection from a data collection service provider 200. In a preferred embodiment, the contract labor provider (CLP) initiates this process by submitting a data request act 210 to the data management system through the data collection system. Furthermore, the data collection system is a web page that is remotely accessible to the CLP via the internet. The CLP completes a data request by filling out a web page form requiring unique employee demographics and a method of selecting the record rules. Each employee has a set of rules that must be complied with. These rules may be unique for each job site and/or for each CLP and are stored in the data storage system for each entity utilizing the data aggregation service provider service.

In an alternative embodiment, a CLP may fill out a paper form requesting that a new employee be entered into the system, or that an existing employee data element be edited. The CLP may mail, fax, or hand carry the request to the data aggregation service provider. Once the data aggregation service provider receives this paper request form a data entry employee will enter the data elements into the data management system via the data collection system.

The data management system (DMS) receives the completed request from the CLP. Once received, the DMS processes the data request in the data request process act 220. Processing the request includes verifying the data elements are unique and extracting corresponding rules. In the event that the employee record is not unique and an existing record is located within the data storage system (DSS), a notification will be sent to the CLP such that the CLP will have an option to edit or read the existing record 222. If the CLP requests read only access of an existing record 222, the CLP will be directed to the data retrieval system (DRS) in the read stored data request act 230. Furthermore, a subscriber may submit a read only data request in the read only data request act 270, directly to the DRS.

In the event that no prior record is located or the CLP opts to edit an existing record, the DMS may request data from the data collection service provider (DCSP) in the data request retrieval act 240. The request occurs only after the initial request is processed and a response is formulated. In a preferred embodiment, the DMS formulates a data request based on the DCSP targeted. For example, a CLP will request that a new employee receive a drug and alcohol test prior to employment at a predefined job site. Based on the request, the DMS queries the rules specific to the applicable job site and formulates an electronic request formatted for the targeted DCSP that specializes in drug and alcohol testing, such as Lab Corp, for example.

Once the DCSP receives the data request in the data request receipt act 242, the DCSP processes the data request in the data receipt process act 244 from the data aggregation service provider (DASP). In one embodiment, the DCSP may be a university admissions office whereby a transcript is requested to verify the award of a degree. In another embodiment, the DCSP may be the county court house whereby a birth certificate is requested to verify citizenship. In yet another embodiment, the DCSP may be another DASP that specializes in gathering both transcripts and birth certificates from their original institutions.

Once the data request is processed the DCSP collects the requested data elements in the data collection act 246. After the data elements are collected, the DCSP sends the requested data elements in the send collected data act 248, to the DMS through the DASP data collection system. The DMS processes the DCSP data elements in the process collected data act 250 and verifies the record is complete 252. In one embodiment, the verification process may be done utilizing optical character recognition (OCR), whereby a document is imaged and the ASCII data is extracted and verified against the original request sent. In an alternative embodiment, the verification process may be achieved utilizing a secure approval code that corresponds to an imaged document.

If the record is not complete 252 the DMS sends another request to the DCSP for the missing data elements in the data request retrieval act 240 and the DMS stores all data elements received in the DSS. In one embodiment, although a record is not complete and part of the data elements is present, the data elements that have been received may be accessible through the DRS. In an alternative embodiment, if the record is not complete, no portion of the record may be accessed through the DRS.

If the DMS verifies the data elements are complete 252, the DMS stores the DSCP data elements in the DSS in the store data act 260. In a preferred embodiment, ASCII data elements are stored in records within the DSS that are linked to the unique employee record. In addition, any forms or documents, such as diplomas, driver's licenses, green cards, or certifications, for example that are an imaged file are stored within file servers wherein the imaged files are linked to the unique employee record in the DSS. Once the DMS stores a complete DCSP record in the DSS in the store data act 260, the data is accessible through the DRS in the read stored data request act 230. In a preferred embodiment, both ASCII and imaged data elements are accessible through a remote interface such as a web browser, for example. In an alternative embodiment, an application may reside on a computer that provides remote access to both ASCII and imaged data elements stored in the DSS.

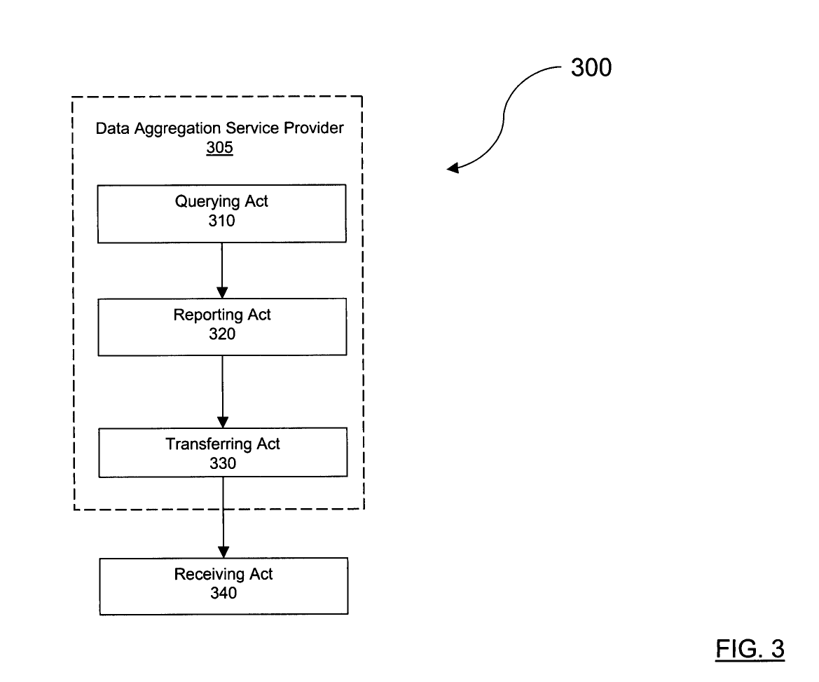

FIG. 3 illustrates a preferred method for automating notification of status of contract labor data elements to DASP 305 system subscribers 300. In a preferred embodiment, the method may be embodied as a single software system. In an alternative embodiment, the method may embody multiple software systems that achieve the same functionality. The method includes a querying act 310, a reporting act 320, a transferring act 330, and a receiving act 340.

The querying act 310 is method whereby the DMS queries the DSS for expiring or expired data elements. Expiring data elements are any data elements wherein a safety test, education qualification, or background check is expiring within a predefined period prior to a date of renewal. For example, drug and alcohol testing renewal is required yearly for heavy machine operators. The querying act 310 utilizes the DMS to identify that the test renewal is required in the next 45 days. In addition, expired data elements are identified in a similar manner with the exception that the renewal date is past due.

The querying act 310 may be any method whereby the DMS queries the DSS for expiring or expired data elements. In a preferred embodiment, the DMS may be setup to automatically run a batch job nightly. In an alternative embodiment, a user may run a single query adhoc utilizing the DMS.

The reporting act 320 is any method whereby the DMS formats the expiring or expired data elements. The DMS formats the data according to the entity receiving the data elements, such as a subscriber, contract labor provider, or job site. In one embodiment, the reporting act 320 may be a completed template that is sent via email in a Postscript Document Format (PDF). In an alternative embodiment, the reporting act may be a Microsoft Word document with a list of expiring or expired data elements. In another embodiment, the reporting act may be a comma delimited string of data elements sent in a flat file. In yet another embodiment, the reporting act may be a facsimile or a pop-up dialog when a user logins to the data retrieval system. All embodiments achieve dissemination of expired or expiring data elements from the DMS to a targeted subscriber, contract labor provider, or job site.

The transferring act 330 is any act that the DASP 305 uses to transfer data elements formatted by the reporting act 320. In a preferred embodiment, the transferring act 330 may be any form of system using connectivity such as Dial-up, DSL, Cable, T1, or OC3, for example that transfers the formatted data elements from the DASP 305 to a subscriber, contract labor provider, or job site. The transfer occurs through the internet or through a secure, dedicated connection such as Virtual Private Network (VPN), for example. In an alternative embodiment, the formatted data elements may be printed out on paper and faxed or sent via mail.

The receiving act 340 is any method that a subscriber, contract labor provider, or job site uses to receive the formatted data. In a preferred embodiment, a job site may receive a list of expired data elements in a PDF daily via their email servers. In an alternative embodiment, a subscriber's company may receive weekly paper reports via mail. Receiving acts 340 are internally managed and are the responsibility of a subscriber, contract labor provider, or job site. In addition, the querying acts 310, reporting acts 320, and transferring acts 330, are internal systems to the DASP 305 and are managed internally by the DASP 305.

Thus, though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

1. A contract labor management system that manages contract labor employee data elements, the system comprising:
a subscriber having at least one contract labor provider providing at least one contract labor employee to at least one subscriber job site;
a data aggregation service provider having a data collection system that collects contract labor data elements for at least one subscriber;
a data collection service provider that collects contract labor employee data elements for a data aggregation service provider.

2. The contract labor management system of claim 1 whereby the contract labor employee data element is a drug test result.

3. The contract labor management system of claim 1 whereby the labor employee data element is a federal criminal record.

4. The contract labor management system of claim 1 whereby the labor employee data element is a trade certification.

5. The contract labor management system of claim 1 whereby the labor employee data element is a commercial vehicle license.

6. The contract labor management system of claim 1 whereby the data aggregation service provider comprises a data management system.

7. The contract labor management system of claim 1 whereby the data aggregation service provider comprises a data storage system.

8. The contract labor management system of claim 1 whereby the data aggregation service provider comprises a data retrieval system.

9. The contract labor management system of claim 1 whereby the contract labor employee is qualified to work at an oil installation.

10. The contract labor data management method of claim 1 whereby the contract labor provider is a skilled labor employment entity providing at least one contract labor employee to operate heavy machinery at a chemical installation.

11. The contract labor data management method of claim 1 whereby the job site is a gas installation whereby a contract labor employee operates a natural gas line at a gas well.

12. The contract labor data management method of claim 1 wherein the job site is a waste water treatment facility whereby a contract labor employee manages the process of dehydrating sludge.

13. The contract labor data management method of claim 1 wherein a contract labor employee is a truck driver that operates a semi on an interstate highway.

14. The contract labor data management method of claim 1 wherein a contract labor employee is a foreman that manages the assembly of automobiles for an automobile manufacturer.

15. The contract labor data management method of claim 1 whereby the data collection service provider is drug and alcohol testing company that collects data elements about a contract labor employee.

16. A contract labor management system that manages contract labor employee data elements, the system comprising:
a subscriber having at least one contract labor provider providing at least one contract labor employee to at least one subscriber job site;
a data aggregation service provider having a data collection system that collects contract labor data elements for at least one subscriber;
a data collection service provider that collects contract labor employee data elements for a data aggregation service provider, whereby,
the data aggregation service provider automatically collects contract labor data elements from a data collection service provider.

17. The contract labor management system of claim 15 whereby the data management system automatically requests a contract labor employee data element from the data collection service provider.

18. The contract labor management system of claim 15 whereby the contract labor employee data stored in the data storage system is accessible to at least one subscriber, contract labor provider, or job site through the data retrieval system.

19. A contract labor management system method in a contract labor management system, the system comprising:
a subscriber having at least one contract labor provider providing at least one contract labor employee to at least one subscriber job site;
a data aggregation service provider having a data collection system that collects contract labor data elements for at least one subscriber;
a data collection service provider that collects contract labor employee data elements for a data aggregation service provider, whereby, the method comprising:
automatically collecting contract labor employee data elements from the data collection service provider, and
automatically notifying at least one subscriber, contract labor provider, data collection service provider, or job site the status of a contract labor employee data element.

20. The contract labor management method of claim 19 whereby automatically notifyng at least one entity is accomplished by a querying act, a reporting act, a transferring act, and a receiving act.

21. The contract labor management method of claim 20 wherein the querying act is the act of the data management system querying the data storage system for the status of contract labor employee data element.

22. The contract labor management method of claim 20 wherein the reporting act is the act of the data management system formatting the status of contract labor employee data element for dissemination to an entity.

23. The contract labor management method of claim 20 wherein the transferring act is the act of the data aggregation service provider transferring the status of formatted contract labor employee data element to an entity.

24. The contract labor management method of claim 20 wherein the receiving act is the act of an entity receiving a formatted contract labor employee data element.

25. A method of verifying regulatory compliance comprising;
identifying a contract labor data element related to a regulation;
adapting a database to monitor a contract labor data element;
monitoring a contract labor data element for at least one contract labor employee to create a contract labor data element result; and
reporting the status of the contract labor data element result;

26. The method of verifying the regulatory compliance of claim 25 wherein the contact labor data element is a drug test.

27. The method of verifying a regulatory compliance of claim 25 wherein receiving a contract labor data element result from a data collection service provider.

28. The method of verifying the regulatory compliance of claim 25 wherein receiving a contract labor data element result from a job site.

29. The method of verifying a regulatory compliance of claim 25 wherein receiving a contract labor data element result from a contact labor provider.

30. The method of verifying a regulatory compliance of claim 25 wherein receiving an indication of a subscription to define a subscriber.

31. The method of verifying a regulatory compliance of claim 25 wherein reporting sends the contract labor data element result to a subscriber.

32. The method of verifying a regulatory compliance of claim 25 wherein reporting the contract labor data element result to a job site.

33. The method of verifying a regulatory compliance of claim 25 wherein reporting sends the contract labor data element result to a data collection service provider.

34. The method of verifying a regulatory compliance of claim 25 wherein adapting is accomplished in a data aggregation service provider, the data aggregation service provider comprising:
a data collection system for receiving contract labor data elements and transmitting contact labor data requests;
a data management system for querying and formatting contract labor data elements and contract labor data requests;
a data storage system for storing contact labor data elements; and
a data retrieval system for displaying a formatting contract labor data requests.

35. The method of verifying a regulatory compliance of claim 25 wherein the data management system formats a regulatory report for a state agency.

36. The method of verifying a regulatory compliance of claim 25 wherein the data management system formats a regulatory report for a federal agency.
